(19) United States
(12) Patent Application Publication
(10) Pub. No.: US 2009/0259659 A1
(43) Pub. Date: Oct. 15, 2009

(54) IDENTIFYING ENTITIES OF INTEREST

(75) Inventor: Eric Michael MERICLE, Henderson, NV (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/103,455

(22) Filed: Apr. 15, 2008

(51) Int. Cl. G06F 17/30

(52) U.S. Cl. 707/7; 707/E17.001

(57) ABSTRACT

Method for identifying entities of interest is provided. The method includes analyzing records to distinguish mergeable records from non-mergeable records and identifying non-mergeable records that have a common attribute and a same value for the common attribute. If the common attribute among the identified non-mergeable records is a unique attribute, then there has been a uniqueness violation of the common attribute. Depending on a violation threshold for the common attribute and a number of uniqueness violations recorded for the common attribute, an alert may be generated to inform a user that entities corresponding to the identified non-mergeable records are of interest.

### BACKGROUND

When dealing with a large number of entities, such as individuals, locations, facilities, organizations, accounts, events, documents, or the like, the ability to identify relationships between the entities is important because there may be potential dangers associated with the entity relationships. For example, social security numbers of different individuals should be unique. Thus, if two different individuals have the same social security number, then someone should be alerted of the suspect relationship between the two individuals.

### SUMMARY

A method for identifying entities of interest is provided. In one implementation, records are analyzed to distinguish mergeable records from non-mergeable records. Two records are mergeable when a degree of similarity between the two records reaches a merging threshold. Each of the records includes attributes of an entity corresponding to the record and a value for each of the attributes. Non-mergeable records that have a common attribute and a same value for the common attribute are identified. A determination is then made as to whether the common attribute among the identified non-mergeable records is a unique attribute. A unique attribute is an attribute in which every value for the attribute should be unique.

In response to the common attribute among the identified non-mergeable records being a unique attribute, it is concluded that there is a uniqueness violation of the common attribute. A determination is also made as to whether a violation threshold for the common attribute is greater than one. In response to the violation threshold for the common attribute being greater than one, the uniqueness violation of the common attribute is recorded and a determination is made as to whether any other uniqueness violations have been recorded for the common attribute. If another uniqueness violation has been recorded for the common attribute, then a determination is made as to whether a number of uniqueness violations recorded for the common attribute has reached the violation threshold for the common attribute. When the number of uniqueness violations recorded for the common attribute has reached the violation threshold for the common attribute, an alert is generated to inform a user that the entities corresponding to the identified non-mergeable records are of interest.

### DESCRIPTION OF DRAWINGS

FIG. 1 depicts a method for identifying entities of interest according to an implementation.

FIG. 2 illustrates different examples of when records corresponding to entities have common attributes with same values for the common attributes.

FIG. 3 shows a system for identifying entities of interest according to an implementation.

FIG. 4 is a block diagram of a data processing system with which implementations of this disclosure can be implemented.

### DETAILED DESCRIPTION

This disclosure generally relates to identifying entities of interest. The following description is provided in the context of a patent application and its requirements. Accordingly, this disclosure is not intended to be limited to the implementations shown, but is to be accorded the widest scope consistent with the principles and features described herein.

Governments and businesses frequently deal with a large number of entities (e.g., individuals, locations, facilities, events, organizations, documents, accounts, or the like). As a result, it is important for governments and businesses to be able to identify relationships between entities in order to determine the potential value or danger of relationships among different entities.

Information concerning entities is typically stored as records. Each record includes attributes (e.g., name, address, phone number, etc.) of a corresponding entity, as well as values (e.g., Bob Smith, 100 Main Street, 212-555-1212, etc.) for the attributes. The attributes included in a record changes depending on the entity. For example, if an entity is a person, then attributes included in a record corresponding to the entity may be first name, last name, social security number, or the like. On the other hand, if an entity is an account, then attributes included in a record corresponding to the entity may be account number, bank name, balance, or the like.

To identify relationships between entities, records corresponding to the entities can be analyzed for similarities. Records that are identical or sufficiently similar may be merged into a single record. The process of merging identical or sufficiently similar records is sometimes referred to as a de-duplication process.

During the de-duplication process, there may be records that have similarities, but are not sufficiently similar to be merged into a single record. These records may be of particular interest because the records, for instance, may be records that should not have any similarities.

For example, suppose there are two records that each corresponds to an individual. In addition, suppose that the two records have an attribute in common and a same value for the common attribute. If the common attribute is one such that no two records should have the same value for the attribute (e.g., bank account number), then the two records should be flagged and someone should be alerted of the suspect relationship between the individuals corresponding to the two records.

To give another example, suppose reward card account numbers are unique (i.e., no two reward cards have the same reward card account number). In addition, suppose that terms of the reward card program prohibit individuals from sharing reward cards. Further, suppose that each time a reward card is used is considered a separate event with its own record. If an unusual number of records have the same reward card account number, then an alert may need to be generated so that an investigation can be conducted as to whether the reward card corresponding to the reward card account number is being shared among multiple individuals, which would be a violation of the terms of the rewards card program.

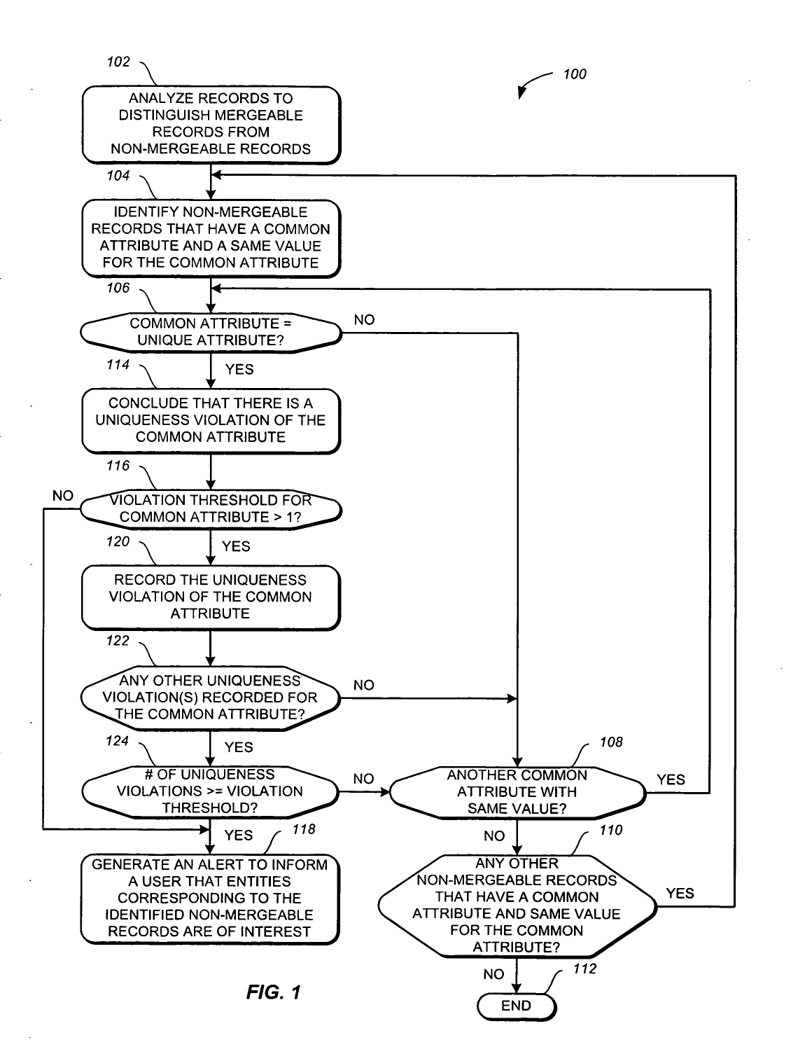

FIG. 1 depicts a method 100 for identifying entities of interest according to an implementation. At 102, records are analyzed to distinguish mergeable records from non-mergeable records. Two records are mergeable when a degree of similarity between the two records reaches a merging threshold. For example, the merging threshold could be set such that if two records are 90% similar, then the two records are mergeable. The merging threshold may be configurable.

To give another example, a point value system can be used such that there is a maximum assignable point value for each attribute that has an identical value. If the values for an attribute are similar, but not identical, then a lesser value could be assigned. Hence, the merging threshold could be a specific point value where if the total point value assigned in determining degree of similarity between records is above the specific point value, then the records are mergeable.

Attributes need not have the same maximum assignable point value. In addition, with the point value system, if an attribute becomes generic (e.g., a significant number of records have a same value for the attribute), then the maximum assignable point value could be reduced or changed to zero to lessen or eliminate the attribute's impact on determination of whether records are mergeable.

Non-mergeable records that have a common attribute and a same value for the common attribute are identified at 104. A determination is made at 106 as to whether the common attribute among the identified non-mergeable records is a unique attribute. A unique attribute is an attribute in which every value for the attribute should be unique.

If the common attribute among the identified non-mergeable records is not a unique attribute, then a determination is made at 108 as to whether there is another common attribute with a same value among at least two of the identified non-mergeable records. If there is another common attribute with a same value among at least two of the identified non-mergeable records, then method 100 returns to block 106.

However, if there is no other common attribute among at least two of the identified non-mergeable records with a same value, then a determination is made at 110 as to whether there are any other non-mergeable records that have a common attribute and a same value for the common attribute. When there are other non-mergeable records that have a common attribute and a same value for the common attribute, then method 100 returns to block 104. Otherwise, method 100 ends at 112.

On the other hand, if it is determined at 106 that the common attribute among the identified non-mergeable records is a unique attribute, then it is concluded at 114 that there is a uniqueness violation of the common attribute. A determination is made at 116 as to whether a violation threshold for the common attribute is greater than one. When the violation threshold for the common attribute is not greater than one, an alert is generated at 118 to inform a user that the entities corresponding to the identified non-mergeable records are of interest.

Generation of the alert may involve, for instance, sending an email, sounding an alarm, sending a page, or the like to the user. The user may be an administrator or someone else that has privileges to access the records and take appropriate action. In addition, the alert may be sent to more than one user.

When the violation threshold for the common attribute is greater than one, the uniqueness violation of the common attribute is recorded at 120. The uniqueness violation of the common attribute can be recorded in, for instance, a table, a list, or something else. A determination is made at 122 as to whether any other uniqueness violations have been recorded for the common attribute. For example, if uniqueness violations are recorded in a list, then the list may be searched to determine whether the list includes any other uniqueness violations of the common attribute.

If no other uniqueness violations have been recorded for the common attribute, method 100 proceeds to block 108. Otherwise, a determination is made at 124 as to whether a number of uniqueness violations recorded for the common attribute has reached the violation threshold. When the number of uniqueness violations recorded for the common attribute has not reached the violation threshold (i.e., is below the violation threshold), method 100 proceeds to block 108. When the number of uniqueness violations recorded for the common attribute has reached the violation threshold (i.e., is at or above the violation threshold), method 100 proceeds to block 118.

The violation threshold may be configurable. In addition, the violation threshold for different attributes need not be the same. Further, the violation threshold may be a threshold for a set period of time (e.g., an hour, a day, a week, or some other time period) that can also be configurable. If the violation threshold is for a set period of time, then recorded uniqueness violations may be cleared upon expiration of the set period of time. This ensures that alerts are not generated when the number of uniqueness violations for the common attribute over a new period of time has not actually reached the violation threshold.

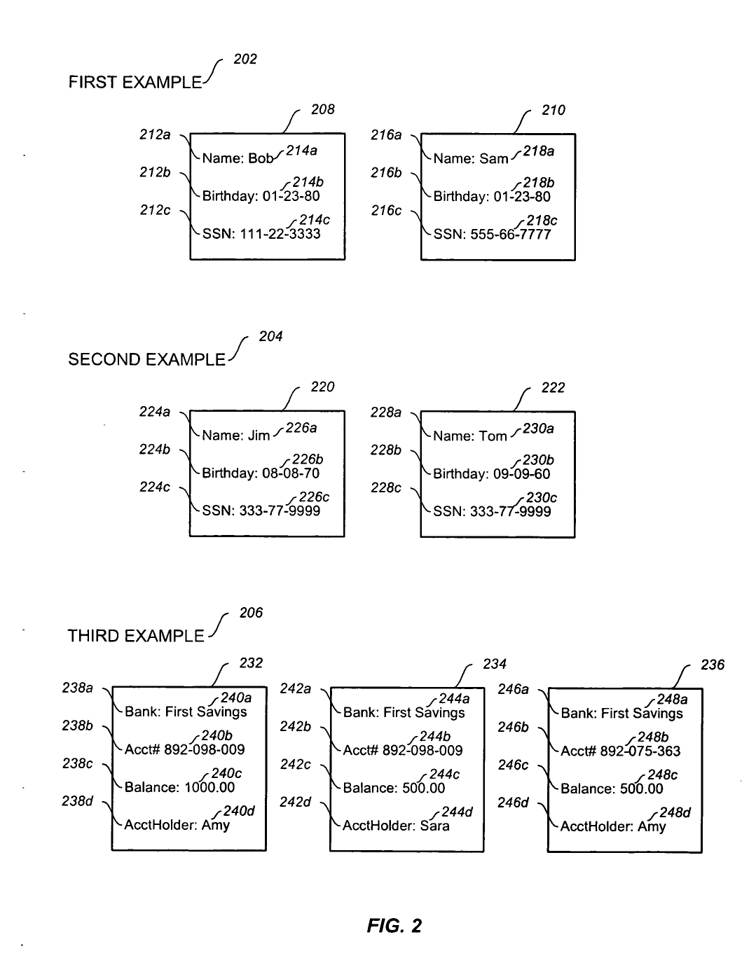

Illustrated in FIG. 2 are three examples 202-206 of when records corresponding to entities have common attributes with same values for the common attributes. In example 202, there are two records 208-210 corresponding to two individuals. Record 208 includes attributes 212a-212c with attribute values 214a-214c, respectively. Record 210 includes attributes 216a-216c with attribute values 218a-218c.

Although all of attributes 212a-212c of record 208 are in common with attributes 216a-216c of record 210, only the attribute value 214b for attribute 212b and the attribute value 218b for attribute 216b matches one another. However, because attributes 212b and 216b are not attributes that should have unique values, the relationship between the individuals corresponding to records 208 and 210 is not suspect. Consequently, an alert need not be generated.

Example 204 involves records 220-222 with attributes 224a-224c and 228a-228c and attribute values 226a-226c and 230a-230c. Similar to records 208-210 in example 202, all attributes 224a-224c of record 220 are in common with attributes 228a-228c of record 222. Unlike records 208-210 in example 202, however, attributes 224c and 228c of records 220-222 with matching attribute values 226c and 230c are attributes that should have unique values. Therefore, an alert may need to be generated since the relationship between entities corresponding to records 220 and 222 may be suspect.

In example 206, there are three records 232-236. Each of records 232-236 corresponds to a bank account and includes four attributes 238a-238d, 242a-242d, and 246a-246d, and four attribute values 240a-240d, 244a-244d, and 248a-248d. The attributes 238a-238d, 242a-242d, and 246a-246d of each of records 232-236 are in common.

Attribute values 240a, 244a, and 248a of common attributes 238a, 242a, and 246a in records 232-236 are the same. Attribute values 240b and 244b of common attributes 238b and 242b in records 232-234 are the same. Attribute values 244c and 248c of common attributes 242c and 246c in records 234-236 are the same. Attribute values 240d and 248d of common attributes 238d and 246d in records 232 and 236 are the same.

Even though there are many common attributes with matching values among records 232-236, the only one that may be of concern is common attributes 238b and 242b with matching attribute values 240b and 244b in records 232 and 234. As a result, an alert may need to be generated for the potentially suspect relationship between the bank accounts corresponding to records 232 and 234.

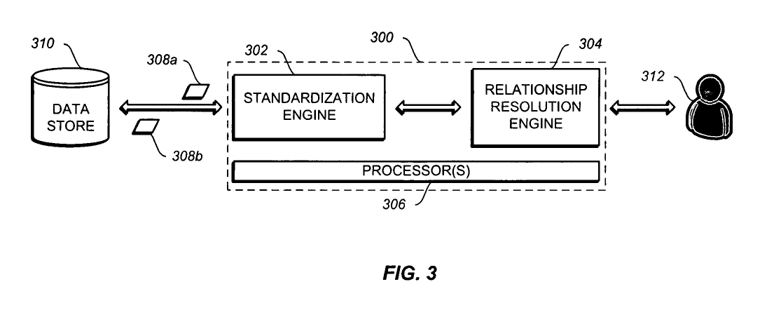

FIG. 3 shows a system 300 for identifying entities of interest according to an implementation. System 300 includes a standardization engine 302 and a relationship resolution engine 304 executing on processor(s) 306. Although not shown in FIG. 3, system 300 may include other components (e.g., memory, storage, other engines, etc.). In addition, standardization engine 302 and relationship resolution engine 304 may be combined into a single engine. Alternatively, the functionalities of one or both of standardization engine 302 and relationship resolution engine 304 may be divided into multiple engines.

In FIG. 3, records 308a and 308b from a data store 310 are processed by system 300 to determine whether entities corresponding to records 308a and 308b are of interest. Data store 310 may be, for instance, a hard disk drive, memory, a flash drive, or the like. Additionally, even though data store 310 is shown in FIG. 3 as being external to system 300, data store 310 may be part of system 300. In one implementation, records 308a and 308b are from multiple data sources (e.g., more than one data store). Records 308a and 308b may also be in different formats.

Standardization engine 302 standardizes records 308a and 308b. For example, if records 308a and 308b include a “Name” attribute, then standardization engine 302 can standardize values for the “Name” attribute (e.g., changing Bob, Rob, Bobbie, Robbie, Bobby, Robby, etc. into Robert). To give another example, if records 308a and 308b include a “Birthday” attribute, then standardization engine 302 can standardize values for the “Birthday” attribute (e.g., changing Oct. 22, 1970, 22-10-70, 10.22.70, etc. into 10-22-70).

Once records 308a and 308b are standardized, relationship resolution engine 304 analyzes records 308a and 308b to determine whether they are mergeable with one another. If records 308a and 308b are mergeable, then records 308a and 308b are merged. Otherwise, relationship resolution engine 304 determines whether records 308a and 308b have any common attributes with a same value for the attribute. If there are no common attributes between records 308a and 308b with the same values, then relationship resolution engine 304 may continue to process other records (not shown).

However, if there is a common attribute with a same value between records 308a and 308b, relationship resolution engine 304 determines whether the common attribute is a unique attribute (e.g., one in which every value should be unique). When the common attribute is a unique attribute, relationship resolution engine 304 will conclude that there is a uniqueness violation of the common attribute and determine whether a violation threshold for the common attribute is greater than 1.

If the violation threshold for the common attribute is not greater than 1, then relationship resolution engine 304 generates an alert to inform a user 312 that entities corresponding to records 308a and 308b are of interest. However, if the violation threshold for the common attribute is greater than 1, then relationship resolution engine 304 records the uniqueness violation of the common attribute (e.g., in data store 310) and determines whether any other uniqueness violations have been recorded for the common attribute.

When at least one other uniqueness violation has been recorded for the common attribute, relationship resolution engine 304 determines whether a number of uniqueness violations recorded for the common attribute is greater than or equal to the violation threshold. If the number of uniqueness violations recorded for the common attribute is greater than or equal to the violation threshold, then relationship resolution engine 304 will generate an alert to inform user 312 that entities corresponding to records 308a and 308b are of interest. Other record(s) involved in the other uniqueness violation(s) recorded for the common attribute may also be identified in the alert.

Although the implementation of FIG. 3 has two records being processed together, more or less records may be processed by system 300 at any one time. For example, system 300 may process one record at a time where mergeability of a record is determined based on a comparison of the record being processed to, for instance, records already processed by system 300 that are stored in data store 310 or somewhere else.

By identifying non-merged records that have a common attribute and a same value for the common attribute and determining whether the common attribute is one in which there should be no duplicate values for the common attribute, governments and businesses can be made aware of entities that have potentially suspect relationships so that appropriate action can be taken. In addition, the generation of alerts can be controlled by setting different violation thresholds. This allows alerts to be generated based not only on the occurrence of duplicate values in non-mergeable records, but also on the frequency in which duplicate values occur in non-mergeable records. Further, alerts generated for these types of suspect entity relationships can be in addition to alerts that may be generated for other issues, such as an attribute becoming generic.

This disclosure can take the form of an entirely hardware implementation, an entirely software implementation, or an implementation containing both hardware and software elements. In one implementation, this disclosure is implemented in software, which includes, but is not limited to, application software, firmware, resident software, microcode, etc.

Furthermore, this disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

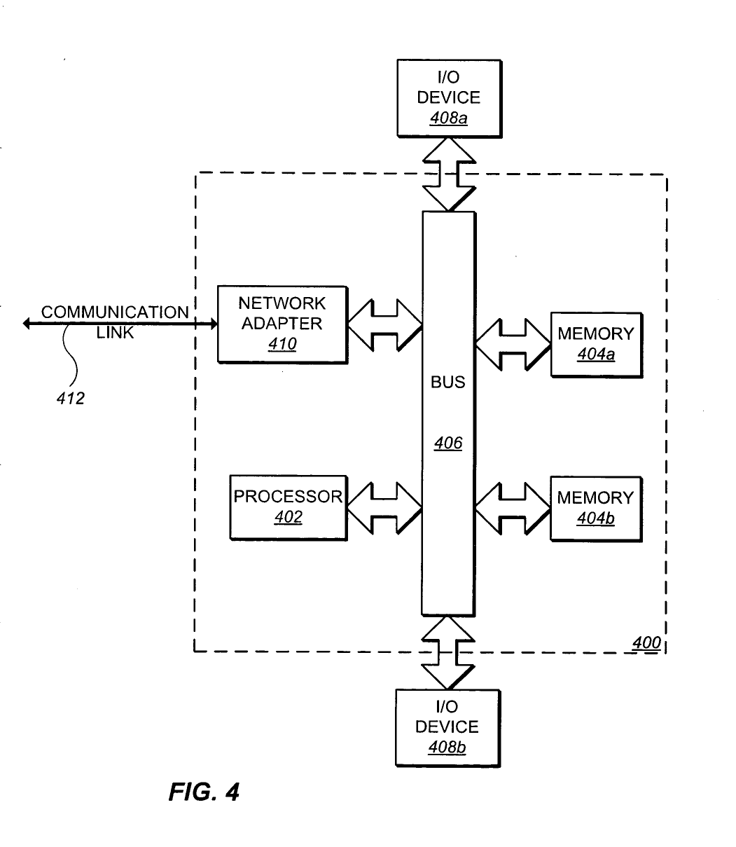

FIG. 4 depicts a data processing system 400 suitable for storing and/or executing program code. Data processing system 400 includes a processor 402 coupled to memory elements 404a-b through a system bus 406. In other implementations, data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to data processing system 400. I/O devices 408a-b may be coupled to data processing system 400 directly or indirectly through intervening I/O controllers (not shown).

In the implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

While various implementations for identifying entities of interest have been described, the technical scope of this disclosure is not limited thereto. For example, this disclosure is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of this disclosure.

1. A method for identifying entities of interest, the method comprising:
analyzing a plurality of records to distinguish mergeable records from non-mergeable records, two records being mergeable when a degree of similarity between the two records reaches a merging threshold, each of the plurality of records including a plurality of attributes of an entity corresponding to the record and a value for each of the plurality of attributes;
identifying non-mergeable records that have a common attribute and a same value for the common attribute;
determining whether the common attribute among the identified non-mergeable records is a unique attribute, a unique attribute being an attribute in which every value for the attribute should be unique;
responsive to the common attribute among the identified non-mergeable records being a unique attribute,
concluding that there is a uniqueness violation of the common attribute, and
determining whether a violation threshold for the common attribute is greater than one;
responsive to the violation threshold for the common attribute being greater than one,
recording the uniqueness violation of the common attribute, and
determining whether any other uniqueness violations have been recorded for the common attribute;
responsive to another uniqueness violation having been recorded for the common attribute, determining whether a number of uniqueness violations recorded for the common attribute has reached the violation threshold for the common attribute; and
responsive to the number of uniqueness violations recorded for the common attribute having reached the violation threshold for the common attribute, generating an alert to inform a user that the entities corresponding to the identified non-mergeable records are of interest.

2. The method of claim 1, wherein responsive to the violation threshold for the common attribute not being greater than one, the method further comprises:
generating an alert to inform the user that the entities corresponding to the identified non-mergeable records are of interest.

3. The method of claim 1, wherein generating an alert comprises sending an email or a page to inform the user that the entities corresponding to the identified non-mergeable records are of interest.

4. The method of claim 1, wherein generating an alert comprises sounding an alarm to inform the user that the entities corresponding to the identified non-mergeable records are of interest.

5. The method of claim 1, wherein the entity corresponding to each of the plurality of records is one of an individual, a facility, an organization, a location, an event, a document, and an account.

6. A computer-readable medium encoded with a computer program for identifying entities of interest, the computer program comprising executable instructions for:
analyzing a plurality of records to distinguish mergeable records from non-mergeable records, two records being mergeable when a degree of similarity between the two records reaches a merging threshold, each of the plurality of records including a plurality of attributes of an entity corresponding to the record and a value for each of the plurality of attributes;
identifying non-mergeable records that have a common attribute and a same value for the common attribute;
determining whether the common attribute among the identified non-mergeable records is a unique attribute, a unique attribute being an attribute in which every value for the attribute should be unique;
responsive to the common attribute among the identified non-mergeable records being a unique attribute,
concluding that there is a uniqueness violation of the common attribute, and
determining whether a violation threshold for the common attribute is greater than one;
responsive to the violation threshold for the common attribute being greater than one,
recording the uniqueness violation of the common attribute, and
determining whether any other uniqueness violations have been recorded for the common attribute;
responsive to another uniqueness violation having been recorded for the common attribute, determining whether a number of uniqueness violations recorded for the common attribute has reached the violation threshold for the common attribute; and
responsive to the number of uniqueness violations recorded for the common attribute having reached the violation threshold for the common attribute, generating an alert to inform a user that the entities corresponding to the identified non-mergeable records are of interest.
